(19) United States
(12) Patent Application Publication
(10) Pub. No.: US 2012/0074049 A1
(43) Pub. Date: Mar. 29, 2012

(54) FILTER ASSEMBLY HAVING METAL MATERIAL IMPROVEMENT

(75) Inventors: Arlen Petersen, Kearney, NE (US); Mitch Bendix, Kearney, NE (US)

(73) Assignee: BALDWIN FILTERS, INC., Kearney, NE (US)

(21) Appl. No.: 13/207,959

(22) Filed: Aug. 11, 2011

Related U.S. Application Data
(60) Provisional application No. 61/385,623, filed on Sep. 23, 2010.

(51) Int. Cl. F01M 11/03; B01D 46/00; B01D 29/00

(52) U.S. Cl. 210/167.08; 210/483; 210/435; 210/232; 210/457; 55/385.3

(57) ABSTRACT

A filter is provided with at least one metal component other than tin coated steel. A suitable metal material may be nickel flash treated steel or other than comparative metal material.

### CROSS-REFERENCE TO RELATED PATENT APPLICATIONS

This patent application claims the benefit of U.S. Provisional Patent Application No. 61/385,623 filed Sep. 23, 2010, the entire teachings and disclosure of which are incorporated herein by reference thereto.

### FIELD OF THE INVENTION

This invention generally relates to fluid filters, and more particularly relates to the metal materials used in such fluid filters.

### BACKGROUND OF THE INVENTION

Tin coated steel, also sometimes referred to as tin has traditionally been used by filter manufactures for decades to produce metal formed parts due to its lubricity and resistance to rust. Considering the environment in which many filters such as engine filters operate (e.g. fuel filters, air filters, oil filters, transmission oil filters, hydraulic oil filters, coolant filters and the like), metal filter component parts typically need to exhibit corrosion protection qualities and be compatible with engine fluids, including for example engine oils, fuels and transmission fluid oils, and hydraulic oils. These characteristics are supplied by tin coated steel even though the raw surface of tin coated steel is readily exposed to such engine fluids when in use.

As a consequence of the established use of tin coated steel, most filter manufacturing lines and their tooling (e.g. progressive stamping dies, drawing machines and the like) are configured and designed to run with tin coated steel.

No known substitutes to tin coated steel are believed to exist as applied to metal filter component parts, at least that have sufficiently comparable properties to that of tin coated steel as discussed above and that are competitively economical enough to be used in engine filters or other such filters.

### BRIEF SUMMARY OF THE INVENTION

According to one inventive aspect, a filter element, comprises filter media coupled to at least one metal component comprising formed sheet steel treated with nickel flash.

In certain preferred embodiments, the nickel flash is at least about 12 mg/m², and more preferably, at least about 20 mg/m².

According to a different inventive aspect, a filter element comprises filter media coupled to at least one metal component comprising a selected metal other than tin coated steel. The selected metal has forming, drawing and corrosion resistance comparable to tin coated steel so that the selected metal can be interchangeably run on lines used for tin coated steel. Yet further, the selected metal being compatible with engine fluids including oil, fuels and transmission fluids.

The at least one metal component may comprise comprises one or more of the following structural parts of a filter: at least one end cap capping an end of the filter media; a housing (also may be referred to as shell) that encloses and carries the filter media within it; a threaded mounting plate having a threaded opening for connection to a mounting adaptor of a fluid circuit; a seaming lid; a perforated center tube; or other such filter structural component. Further, the at least one metal component is arranged along and exposed to a fluid flow path that runs through the filter media, wherein the filter element is one of an oil and a fuel filter. The filter element is thus subjected to at least one engine fluid when in use selected from the group of engine oil, fuel and transmission fluids.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a cross-section illustration of a spin-on hydraulic oil filter having metal components comprising nickel flash in accordance with a first embodiment of the present invention;

FIG. 2 is an enlarged cross-section of a portion of FIG. 1; and

FIG. 3 is a cross-section illustration of an open filter having metal components comprising nickel flash in accordance with a second embodiment of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Referring to the embodiments, each one includes one component or multiple components that are formed or made from sheet steel treated with nickel flash. In certain preferred embodiments and while other embodiments may be employed, the nickel flash is at least about 12 mg/m², and more preferably, at least about 20 mg/m² (measured as a material grade prior to forming/stamping operations) is preferable even though not as commonly available (6 or 12 mg/m² are more common). The nickel flash material is commercially available such as from ArcelorMittal I/N Tek facility located in New Carlisle, Ind.

The selected nickel flash treated sheet steel is a metal has forming, drawing and corrosion resistance comparable to tin coated steel so that the selected metal can be interchangeably run on lines used for tin coated steel. Yet further, the selected metal being compatible with engine fluids including oil, fuels and transmission fluids. As such, it may also be used in combination with tin coated steel or other metal components in the embodiments.

It is also noted that while painting of nickel flash is suggested and its normal use, the present application envisions not typically using paint, other than perhaps the outside of metal housings for labeling, branding, aesthetics and the like. Internal components needs not be painted and preventing the potential for paint chips from entering an engine fluid circuit is desirable in the filter art. However, preservative coatings such as anti-rusting oil, or other oils/fluids used in metal stamping/drawings may be employed for anti-corrosive enhancement. Unlike typical painting applications, keeping anti-rusting oil on the metal surface can be accomplished.

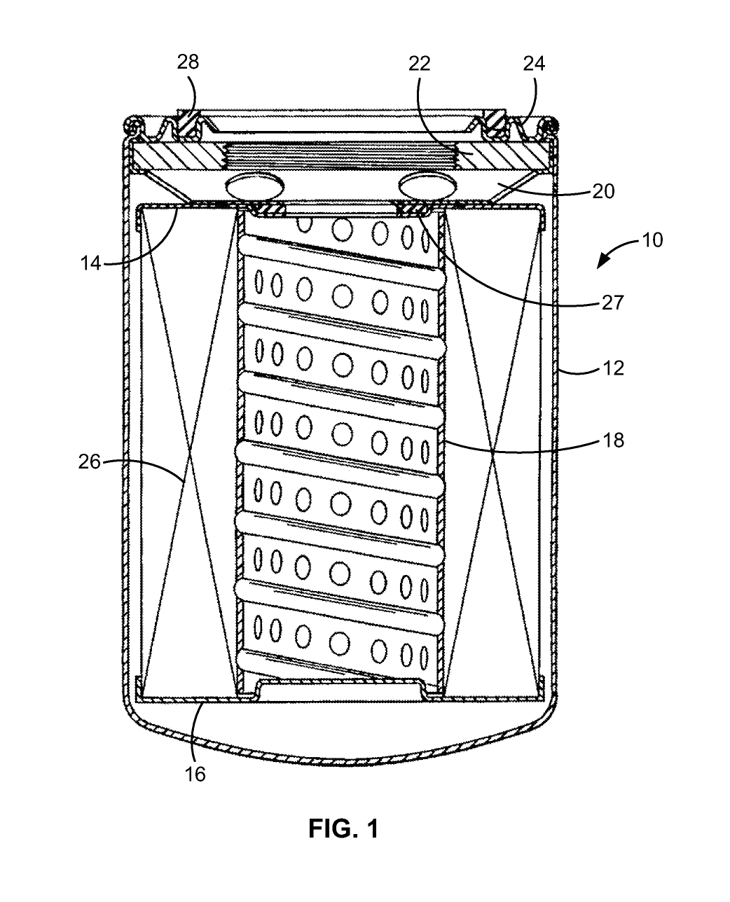

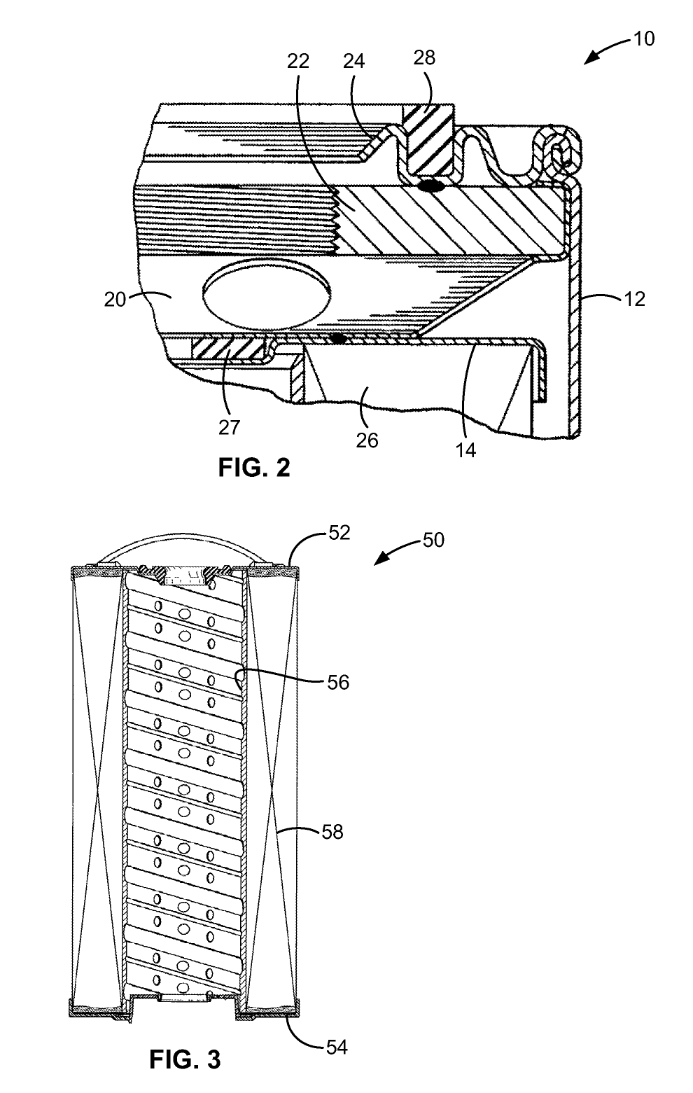

For example, FIG. 1 is liquid filter 10 (may be oil, fuel, hydraulic or the like) comprising the following metal components: an outer canister housing 12; top and bottom end caps 14, 16; a perforated center tube support structure 18, a seal retainer and perforated spacer 20, a threaded mounting plate 22, and a seaming lid 24. All or at least some of these metal components are formed from nickel flash treated steel (or other suitable metal comparable to tin coated steel).

The canister housing 12 is deep drawn with a closed end and an open end and serves to enclose a filter media such as a pleated filter media ring 26, inside thereof. The top and bottom end caps 14, 16 are typically annular and may be cup shaped to received adhesive such as plastisol for sealingly bonding to opposed ends of the filter media ring. The spacer 20 in this embodiment spaces the mounting plate 22 from the top end cap 14 and has holes to provide for a path for unfiltered fluid radially outward to a region between the cylindrical wall of the canister housing 12 and the outside of the pleated filter media ring 26. The spacer 20 may also be used for retention of an internal seal 27. The threaded mounting plate 22 has a threaded opening to provide for spin-on attachment to a mounting adapter of an engine that also serves to provide for inlet and outlet ports. In some embodiments (not shown), the mounting plate 22 will include a central port and a plurality of peripheral ports (e.g. the function of the spacer—such that the space is optional and may be combined with the mounting plate) to provide dedicated and separate inlet and outlet ports for communication with an engine fluid circuit. The seaming lid 24 is joined through a hem or seam to the edge of the canister and extends over the mounting plate 22 to secure it thereto and may be used for retention of an external gasket 28. Again, the functions of these components may vary depending upon the configuration and some components are optional. For example, certain embodiments may not include a spacer or a seaming lid—e.g. the canister may be directly used through a J-lock or L-lock to the mounting plate (see e.g. U.S. Publication No. 2010-0044293 assigned to the present assignee—the entire disclosure of which is incorporated by reference thereto; see also U.S. Publication No. 2007-0114170 the entire disclosure of which is incorporated by reference thereto where no mounting plate is needed and a housing section doubles as an end cap). With the filter 10, unfiltered fluid can flow to the outside of the media ring 26, through the media ring trapping particulates on the media, whereby clean fluid is collected in the center tube for return (in some circuits this flow can be reversed).

Another embodiment, an open filter 50 is provided which is mounted in a housing that is part of the engine, and as such has fewer components than the first embodiment. For example, this embodiment has two metal (e.g. nickel flash) end caps 52, 54, a perforated center tube 56 and a pleated filter paper media ring 58. Sealing grommets 60 may also be employed.

### EXAMPLES AND METHODOLOGY

First, ability with the same tooling as tin coated steel including progressive stamping dies and drawing machines is also considered for compatibility. Also, some expectation that a metal stock material will be economically comparative to tin coated steel may also be considered.

To test suitability, different metal disc samples of test metals are subjected to a selected test engine fluid at elevated temperature (e.g. 180° F.) for soak test of 500 hours and then visually inspected and microscopically inspected to view potential changes. Different samples are subjected to different engine fluid tests. For example, the various engine fluids may include ultra low sulfur diesel (ULSD), various grades of methyl soyate biodiesel, various grades of yellow grease bio diesel, various blends of gasoline (including non-ethanol, E10 and E85 ethanol blends), engine oil, hydraulic oil, antifreeze coolant, phosphate-ester hydraulic oil and ester based synthetic engine oil, and transmission fluids. A selected metal that shows little or no degradation for a fluid can be considered a suitable tin coated steel replacement.

### Example 1

Multiple 12 mg/m² treated sheet steel disks were subjected to different fluid soaks selected from fluids of the list above. Samples tested in engine oil, engine coolant, ester based synthetic engine oil, ULSD, phospate-ester hydraulic oil, gasoline, E85, and B100 of yellow grease fluids did not nave any noticeable effect on the samples after being subjected to testing conditions. Certain biodiesel blends made from methyl soyate and biodiesel blends made from yellow greases exhibited after testing some yellow spots which could be due to corrosion.

### Example 2

Multiple 20 mg/m² treated sheet steel disks were subjected to different fluid soaks of the list above, except that tests were not rerun on some of the tests passed by the 12 mg/m² treated sheet steel disks. The overall appearance of the metal samples did not appear to show any noticeable changes due to the soak test after completion of the storage period, including for the test fluids of biodiesel blends made from methyl soyate and biodiesel blends made from yellow greases.

### Example 3

Acrylic coated galvanized steel samples were subjected to various fluid soak tests selected from the fluids of the list above. It was determined from inspection that engine oil, engine coolant, hydraulic oil, ester based synthetic engine oil, and ultra low sulfur diesel fuel did not have any noticeable effect on metal disc samples after the testing. Metal samples tested in phosphate ester based hydraulic oil had some areas where the coating had turned white. Biodiesel blends made from yellow grease had the coating change into patterns of light and dark areas. Biodiesel blends made from methyl soyate left brown residues on the discs and changed the color of the metal discs. Interaction between methyl soyate biodiesel blend and the coating could have caused the coating to be removed from the metal sample leading to metal disc corrosion.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter element, comprising: filter media coupled to at least one metal component comprising formed sheet steel treated with nickel flash.

2. The filter element of claim 1, wherein the nickel flash is at least about 12 mg/m².

3. The filter element of claim 2, wherein the nickel flash is at least about 20 mg/m².

4. The filter element of claim 1, wherein the at least one metal component is unpainted.

5. The filter element of claim 1, wherein the at least one metal component comprises at least one end cap affixed to and capping an end of the filter media.

6. The filter element of claim 1, wherein the at least one metal component comprises a housing, the filter media being enclosed and carried within the housing.

7. The filter element of claim 1, wherein the at least one metal component comprises a threaded mounting plate having a threaded opening, the threaded mounting plate adapted for connection to a mounting adaptor of a fluid circuit.

8. The filter element of claim 1, wherein the at least one metal component comprises a seaming lid.

9. The filter element of claim 1, wherein the at least one metal component comprises a perforated center tube arranged centrally within the filter media.

10. The filter element of claim 1, wherein the at least one metal component is arranged along and exposed to a fluid flow path that runs through the filter media, wherein the filter element is one of an oil and a fuel filter, the filter element being subjected to at least one engine fluid when in use selected from the group of engine oil, fuel and transmission fluids.

11. A filter element, comprising filter media coupled to at least one metal component comprising a selected metal other than tin coated steel, the selected metal having forming, drawing and corrosion resistance comparable to tin coated steel so that the selected metal can be interchangeably run on lines used for tin coated steel, and the selected metal being compatible with engine fluids including oil, fuels and transmission fluids.

12. The filter element of claim 11, wherein the at least one metal component is unpainted.

13. The filter element of claim 11, wherein the at least one metal component comprises at least one end cap affixed to and capping an end of the filter media.

14. The filter element of claim 11, wherein the at least one metal component comprises a housing, the filter media being enclosed and carried within the housing.

15. The filter element of claim 11, wherein the at least one metal component comprises a threaded mounting plate having a threaded opening, the threaded mounting plate adapted for connection to a mounting adaptor of a fluid circuit.

16. The filter element of claim 11, wherein the at least one metal component comprises a seaming lid.

17. The filter element of claim 11, wherein the at least one metal component is arranged along and exposed to a fluid flow path that runs through the filter media, wherein the filter element is one of an oil and a fuel filter, the filter element being subjected to at least one engine fluid when in use selected from the group of engine oil, fuel and transmission fluids.

18. The filter element of claim 11, wherein the at least one metal component comprises a perforated center tube arranged centrally within the filter media.

19. The filter element of claim 11, wherein the selected metal comprises sheet steel treated with nickel flash.

20. The filter element of claim 11, wherein the filter element is an air filter element.
